(19) United States
(12) Patent Application Publication
(10) Pub. No.: US 2025/0356228 A1
(43) Pub. Date: Nov. 20, 2025

(54) RESOURCE OPTIMIZED QUANTUM SQUARING

(71) Applicant: UNIVERSITY OF NORTH TEXAS, Dallas, TX (US)

(72) Inventors: Edgard MUÑOZ-COREAS, Dallas, TX (US); Afrin SULTANA, Dallas, TX (US)

(21) Appl. No.: 18/662,969

(22) Filed: May 13, 2024

Related U.S. Application Data
(60) Provisional application No. 63/501,852, filed on May 12, 2023.

(51) Int. Cl. G06N 10/20; G06N 10/60

(52) U.S. Cl. CPC G06N 10/20; G06N 10/60

(57) ABSTRACT

Aspects of the disclosure provide for a method. In some examples, the method includes determining partial products for a multi-bit value. The method also includes performing quantum full adder and quantum half adder operations sequentially in a loop for a programmed number of iterations. The method also includes storing a result of the quantum full adder and quantum half adder operations as a square of the multi-bit value. The method also includes uncomputing the partial products and the quantum full adder and quantum half adder operations.

### CROSS-REFERENCE TO RELATED APPLICATIONS

The present application claims priority to U.S. Provisional Patent Application No. 63/501,852, which was filed on May 12, 2023, is titled RESOURCE OPTIMIZED QUANTUM CIRCUITS FOR SQUARING OPERATION, and which is incorporated herein by reference in its entirety.

### STATEMENT REGARDING FEDERALLY SPONSORED RESEARCH OR DEVELOPMENT

None.

### BACKGROUND

A quantum squaring operation may be a useful building block in implementing quantum algorithms, such as linear regression, regularized least squares algorithm, order-finding algorithm, quantum search algorithm, Newton Raphson division, Euclidean distance calculation, cryptography, and in finding roots and reciprocals. However, quantum operations are prone to noise errors. Quantum error correcting codes and fault tolerant gate sets (such as Clifford+T gates) can increase fault tolerance of quantum circuits. However, circuit implementations that use T-gates can present challenges.

### SUMMARY

In some examples, an apparatus includes a first logic circuit, a quantum adder, and a quantum logic circuit. The first logic circuit is configured to provide partial products of a multi-bit value, the partial products stored as ancilla. The quantum adder is coupled to the first logic circuit, the quantum adder configured to add the partial products to provide a square of the multi-bit value. The quantum logic circuit comprises uncomputation gates, the quantum logic circuit configured to uncompute the partial products based on the partial products and the multi-bit value.

In some examples, an apparatus includes a logic circuit, a computation circuit, and an uncomputation circuit. The logic circuit is configured to determine partial products for a multi-bit value, the partial products stored as ancilla. The computation circuit is configured to iteratively process the partial products in a loop with carry output values to determine a square of the multi-bit value. The uncomputation circuit is configured to reverse operations of the computation circuit and the logic circuit to restore the ancilla to a value held prior to determining the partial products.

In some examples, a method includes determining partial products for a multi-bit value. The method also includes performing quantum full adder and quantum half adder operations sequentially in a loop for a programmed number of iterations. The method also includes storing a result of the quantum full adder and quantum half adder operations as a square of the multi-bit value. The method also includes uncomputing the partial products and the quantum full adder and quantum half adder operations.

### BRIEF DESCRIPTION OF THE DRAWINGS

FIGS. 1A and 1B show an example algorithm for implementing the quantum squaring operation based on the use of logical-AND operations.

FIG. 2 is a diagram illustrating generation of partial products in the quantum squaring operation, in accordance with various examples.

FIG. 3 is a diagram illustrating arrangement of the generated partial products in the quantum squaring operation, in accordance with various examples.

FIG. 4 is a diagram illustrating ancillae loading in the quantum squaring operation, in accordance with various examples.

FIG. 5 is a diagram illustrating loading of values from a quantum register to a first quantum adder, in accordance with various examples.

FIG. 6 is a diagram illustrating quantum addition, in accordance with various examples.

FIG. 7 is a diagram illustrating quantum addition, in accordance with various examples.

FIG. 8 is a diagram illustrating uncomputation, in accordance with various examples.

FIG. 9 is a block diagram of a system, in accordance with various examples.

### DETAILED DESCRIPTION

In the areas of numbers theory, encryption, and scientific computing, quantum algorithms for tasks, such as multivariate integration, path integration, the solution of ordinary and partial differential equations, eigenvalue problems, and numerical linear algebra problems, can achieve up to a super polynomial factor speedup compared to classical counterparts. Quantum hardware data paths are needed to implement these algorithms. Quantum implementations for mathematical computations, such as fractional exponents, multiplication, squaring, and addition may be used to implement algorithms in these fields. For example, a quantum squaring circuit (QSC) may be used as a building block for more complex quantum data path systems. Squaring is used in the calculation of fractional exponents, such as with Taylor's series and in Newton Raphson division, roots, and reciprocals. Several digital signal processing (DSP) applications (e.g., audio processing and Euclidean branch calculation) use squaring, as does image processing, adaptive filtering, decoding, least mean squaring, exponential calculation in cryptography, and transformation from rectangular to polar coordinates.

However, as described above, quantum computers are prone to noise errors. At least some current quantum computer implementations do not have sufficient resources to implement quantum error correcting codes. As a result, when working with these Noisy Intermediate Scale Quantum (NISQ) machines, the number of CNOT gates may be a resource cost measure of interest. The CNOT gate is more prone to noise errors than single qubit gates. Furthermore, Coherence errors (such as T1 and T2 errors) may be a function of time, which is related to depth. As a result, the CNOT gate count and CNOT depth may be measures of interest. In addition, due to the limited resources on at least some current quantum computer implementations, the number of qubits is a relevant resource cost metrics. The qubit cost can be calculated by taking the sum of the number of input qubits and the ancillae.

T-gates can aid in increasing fault tolerance and thereby mitigating at least some errors. T-gates may be comparatively costlier to implement, such as based on a physical space consumed by the T-gates, than approaches that lack the T-gates. As a result, it may be desirable to optimize a T-gate count in designing quantum circuits. Because two qubit gates (such as the CNOT gate) are more prone to noise errors than single qubit gates, in some examples, to realize reliable quantum algorithms, the quantum circuits should have a low T-count and CNOT count. Aspects of this disclosure provide for a quantum integer squaring architecture optimized for T-count, CNOT count, T-depth, CNOT depth, and KQ_{T}, which is the product of the number of qubits and the T-depth of the circuit. As used herein, the T-count is the total number of T-gates or Hermitian transpose of T-gates in a circuit, the T-depth is the is the number of T-gate layers in the circuit where a layer includes those T-gate quantum operations that can be performed simultaneously, the CNOT count is the total number of CNOT gates in a circuit, and the CNOT depth is the is the number of CNOT gate layers in the circuit where a layer includes those CNOT gate quantum operations that can be performed simultaneously

In at least some examples, the architecture produces no garbage outputs. To reduce costs, the generated partial products may be arranged to reduce the number of adders by up to about 50%. Some examples may also utilize the logical-AND gate and uncomputation gate to further save resources, thereby reducing the cost of implementation of quantum squaring circuits.

In an example, the quantum squaring circuit of this disclosure is garbage less and with a lower T-count, T-depth, CNOT-count, CNOT-depth, KQ_{T} compared to other quantum squaring circuits. In a first example, the building blocks of the quantum squaring circuit are a quantum adder, logical AND gates, and the inverse (or uncomputation) of the logical AND gate. Further information regarding the quantum adder, logical AND gates, and the inverse of the logical AND gate suitable for use in the disclosed quantum squaring circuit may be found in C. Gidney, “Halving the cost of quantum addition,” Quantum Journal, 2018, which is incorporated herein by reference in its entirety.

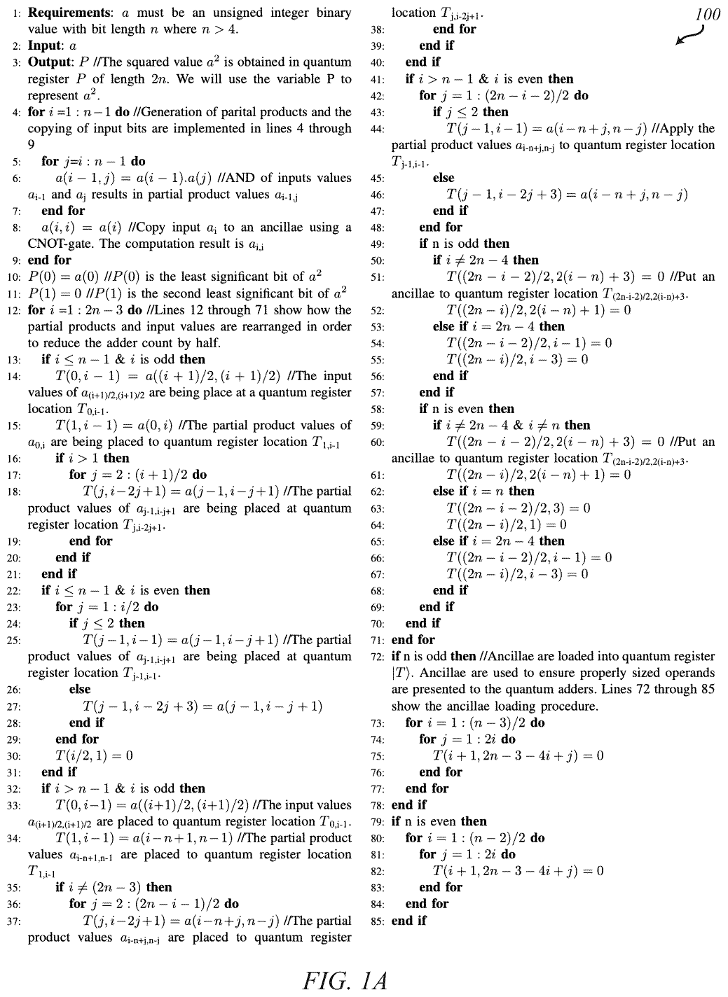

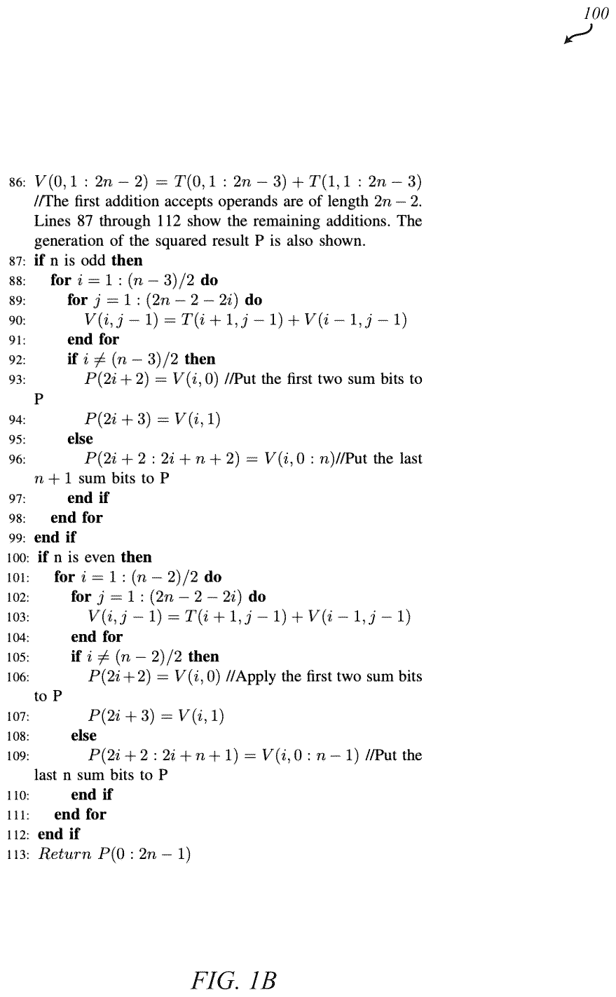

A quantum squaring operation of a quantum squaring circuit having a reduced T-count, T-depth, CNOT count, CNOT depth, KQT compared to other approaches will be described below with reference to FIGS. 1-6. The quantum squaring operation illustrates the squaring of an n-bit number a stored in quantum register |A [symbol] , with a quantum output register |P [symbol] of size 2n that is initialized to 0. At the end of computation, register |P [symbol] would have the square of a. As described herein, the quantum squaring operation can perform the squaring of a 6-bit number a (e.g., a=a₅a₄a₃a₂a₁a₀). However, the methodologies and architecture described herein with respect to the quantum squaring operation may be extended and applicable to the squaring of a number having any quantity of bits.

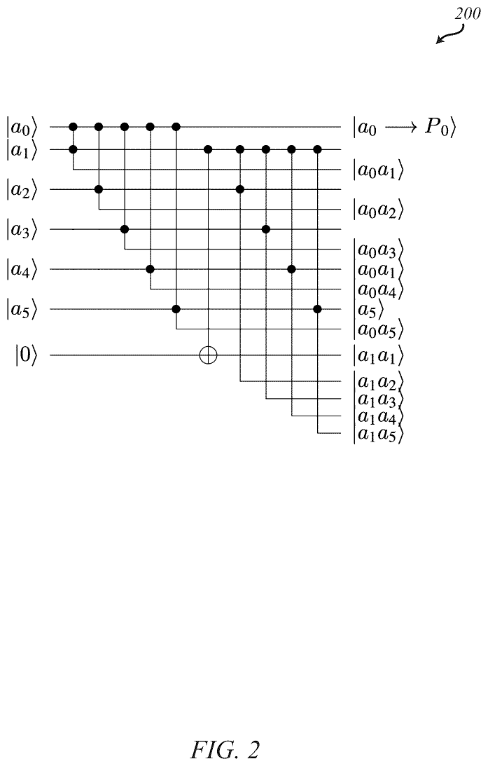

An example algorithm 100 for implementing the quantum squaring operation based on the use of logical-AND operations is shown beginning in FIG. 1A and continuing to FIG. 1B. Individual steps of the quantum squaring operation are described below with respect to FIGS. 2-6 and reference to FIGS. 1A and 1B.

FIG. 2 is a diagram 200 illustrating generation of partial products in the quantum squaring operation, in accordance with various examples. The partial product generation may be a first step of multiple steps in performing the quantum squaring operation. As shown in FIG. 2, two or more solid dots aligned vertically represent a logical-AND operation (performed by a respective logical-AND circuit) between those respective data values, and a solid dot and an outlined circle aligned vertically represents a CNOT operation (performed by a respective CNOT gate) between those respective data values.

In the first step of the quantum squaring operation, the input bits of the number a are input to logical-AND circuits. At the end of the first step of the quantum squaring operation, partial products such as |a₀a₁ [symbol] , |a₀a₂ [symbol] , |a₀a₃ [symbol] . . . have been generated using the logical-AND circuits. The input bits of the number a are also copied to be later arranged to feed to adders. The least significant bit |P₀ [symbol] of the squared value is generated in this step. For example, the value |a₀ [symbol] may be the least significant bit |P₀ [symbol] of the squared value of the input a. In an example, a is an unsigned integer binary value with a length n, where n>4 (as shown in FIG. 1, n=6). The first step of the quantum operation, as illustrated in FIG. 2, may correspond to lines 4 through 11 of the algorithm 100.

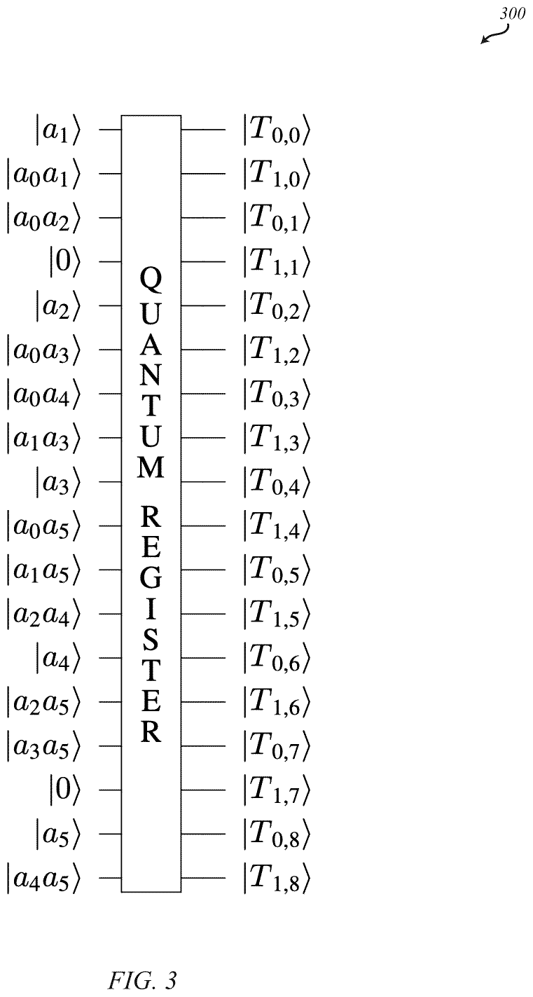

FIG. 3 is a diagram 300 illustrating arrangement of the generated partial products in the quantum squaring operation, in accordance with various examples. The arrangement of the generated partial products may be a second step of the multiple steps in performing the quantum squaring operation.

In the second step of the quantum squaring operation, the generated partial products are arranged specifically and stored in a temporary quantum register |T [symbol] . The arrangement of the generated partial products may be done to reduce the number of the adders to approximately half of the number used in other quantum squaring approaches that lack the arrangement of this disclosure. Values of |T_{0,j} [symbol] and |T_{1,j} [symbol] where j=0, 1, 2 . . . 2n−2, from the array are feed to quantum adder in a subsequent step of the quantum squaring operation, and the remaining partial products from the array are fed to a quantum adder in other subsequent steps of the quantum squaring operation. The second step of the quantum operation, as illustrated in FIG. 3, may correspond to lines 12 through 71 of the algorithm 100.

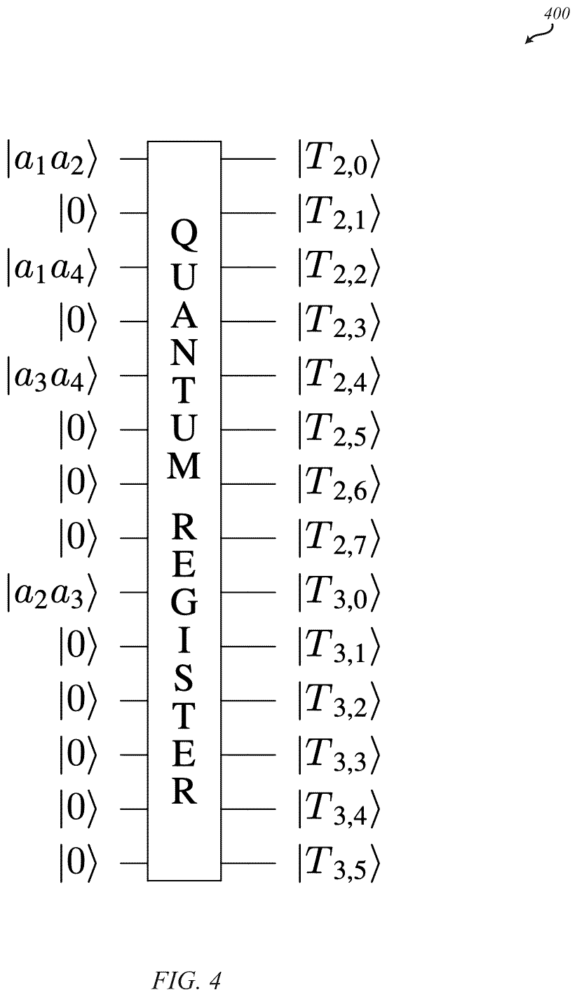

FIG. 4 is a diagram 400 illustrating ancillae loading in the quantum squaring operation, in accordance with various examples. The ancillae loading may be a third step of the multiple steps in performing the quantum squaring operation. The ancillae loading, or zero-padding, may be performed to remaining locations of |7), such as to provide properly sized operands to the quantum adders. The third step of the quantum operation, as illustrated in FIG. 4, may correspond to lines 72 through 85 of the algorithm 100.

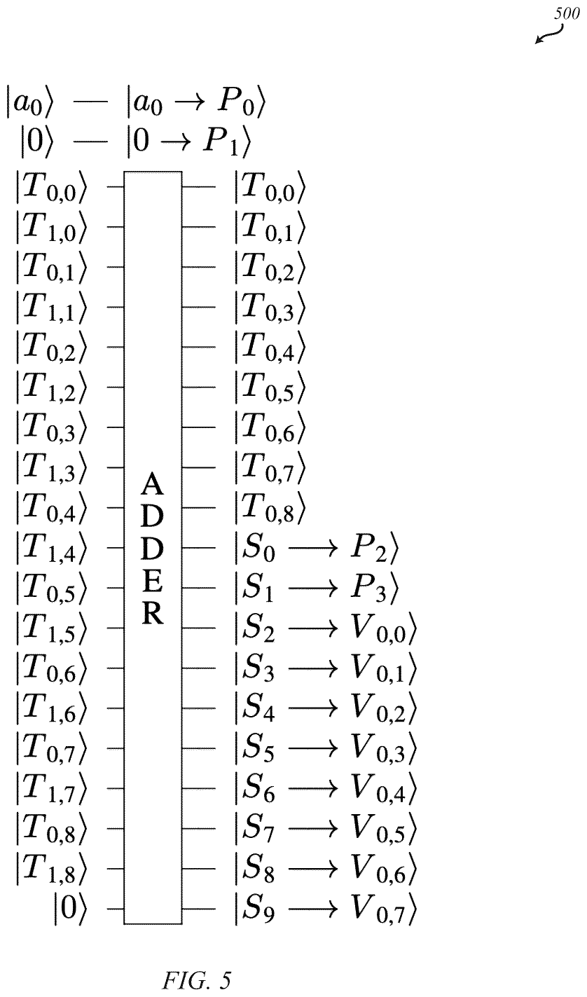

FIG. 5 is a diagram 500 illustrating loading of values from |T [symbol] to a first quantum adder, in accordance with various examples. Diagram 500 may be representative of a fourth step of the multiple steps in performing the quantum squaring operation. In an example, values |T_{0,0} [symbol] to |T_{0,2n-2} [symbol] , and values |T_{1,0} [symbol] to |T_{1,2n-2} [symbol] are applied as 2n-3 bit operands to a 2n-3 bit quantum adder. At the end of computation, a 2n-2 bit sum is produced. The sum bits |S₀ [symbol] , |S₁ [symbol] are bits |P₂ [symbol] , and |P₃ [symbol] of the squared value of input a. The remaining 2n-4 sum output bits are stored in a quantum register |V [symbol] . The fourth step of the quantum operation, as illustrated in FIG. 5, may correspond to line 86 of the algorithm 100.

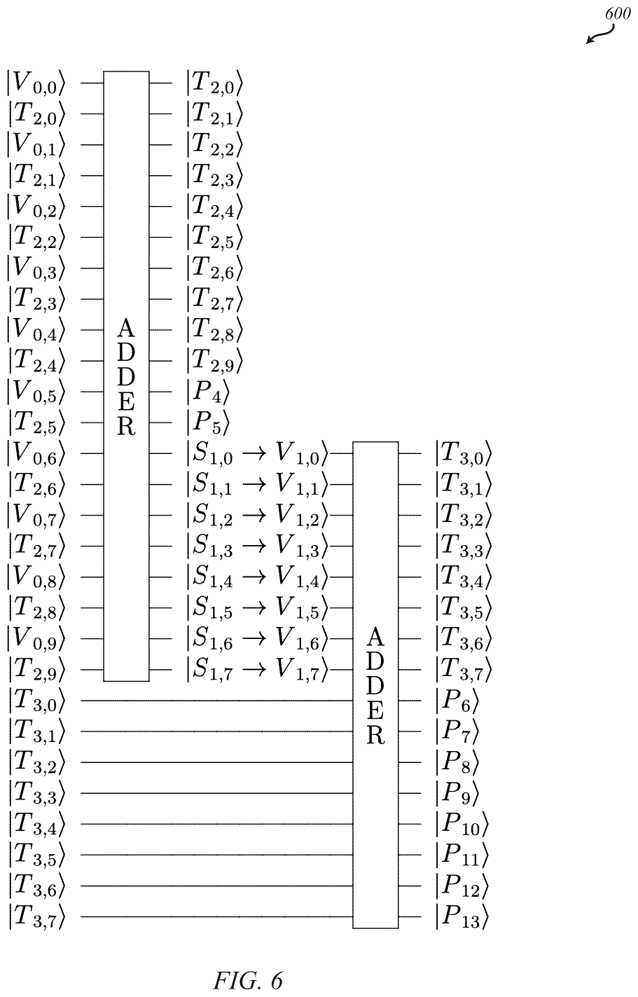

FIG. 6 is a diagram 600 illustrating quantum addition, in accordance with various examples. Diagram 600 may be representative of a fifth step of the multiple steps in performing the quantum squaring operation. In an example, the fifth step is performed for cases in which n is odd. In the fifth step, (n−3)/2 additions are performed. For each addition, two bits of the final squared value of a are generated. Each quantum adder may take partial products stored in register |T [symbol] as inputs, as well as the remaining sum bits from the last round of computation, which is stored in the quantum register |V [symbol] . The fifth step of the quantum operation, as illustrated in FIG. 5, may correspond to lines 87 through 99 of the algorithm 100.

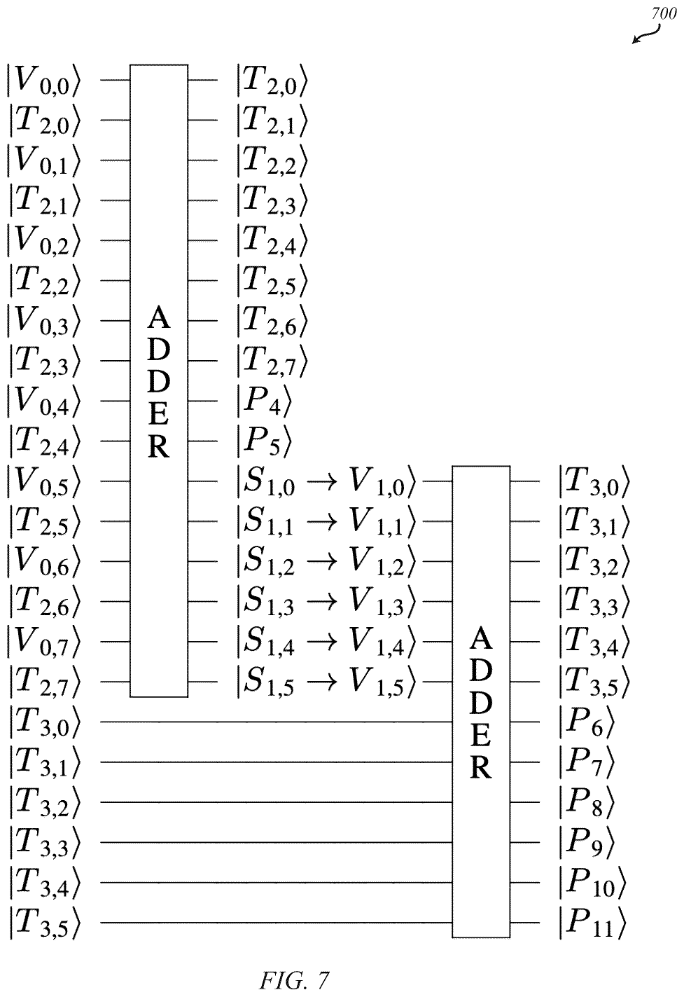

FIG. 7 is a diagram 700 illustrating quantum addition, in accordance with various examples. Diagram 700 may be representative of a sixth step of the multiple steps in performing the quantum squaring operation. In an example, the sixth step is performed for cases in which n is even. In the sixth step, (n−2)/2 additions are performed. For each addition, two bits of the final squared value of a are generated. Each quantum adder may take partial products stored in register |T [symbol] as inputs, as well as the remaining sum bits from the last round of computation, which is stored in the quantum register |V [symbol] . The fifth step of the quantum operation, as illustrated in FIG. 5, may correspond to lines 100 through 112 of the algorithm 100.

Following the completion of the sixth step, a seventh step of the multiple steps in performing the quantum squaring operation is performed. In the seventh step, the qubits of the copied values of input a produced in the first step are restored to their original ancillae values. For example, for i=1:2:2n-3, input values |a_{(i+1)/2} [symbol] and the quantum register value |T_{0,i-1} [symbol] are applied to CNOT-gates. At the end of computation, copied bits of input a located in |T_{0,i-1} [symbol] position will be restored to an initial value 0. Subsequently, an eighth step of the multiple steps in performing the quantum squaring operation is performed. In the eighth step, the original input bits of a and the partial products produced in the first step are restored to their original values of input a.

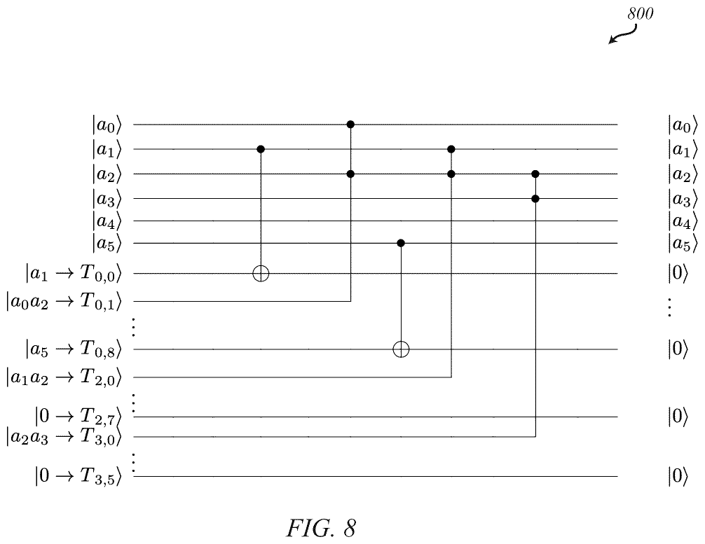

FIG. 8 is a diagram 800 illustrating uncomputation, in accordance with various examples. The uncomputation may be of partial products, such as generated as described above herein, intermediate computation values, such as stored in a quantum register, or the like.

In some examples, the uncomputation may be a final step of multiple steps in performing a quantum squaring operation. In other examples, the uncomputation may be a separate operation that follows the quantum squaring operation. As shown in FIG. 8, two or more solid dots aligned vertically represent a logical-AND operation (performed by a respective logical-AND circuit) between those respective data values, and a solid dot and an outlined circle aligned vertically represents a CNOT operation (performed by a respective CNOT gate) between those respective data values. As shown by FIG. 8, based on the computation, the input bits of the number a and various ancilla bits of register values, such as of the quantum registers |T [symbol] and/or |V [symbol] are restored to their original values, such as the values prior to execution of the algorithm 100. In an example, the uncomputation may be performed according to an algorithm as shown in the following Table 1.

```
TABLE 1
If i ≤ n−1 and i is odd, then apply input |a₁ [symbol]   , |aᵢ₋₁ [symbol]   and partial product |T_{2,i-3} [symbol]   to an
uncomputation gate;
If i>3, then
  For i₁=(i−1)/2, apply input |aᵢ_{₁}₊₁ [symbol]   , |aᵢ₋ᵢ_{₁}₋₁ [symbol]   and partial product |T₂₊ᵢ_{₁}_{,i-3-2*i}_{₁} [symbol]   to an
uncomputation gate;
If i ≤ n−1 and i is even, then apply input |a₀ [symbol]   , |aᵢ [symbol]   and partial product |T_{0,i-1} [symbol]   to an
uncomputation gate;
If i>4, then
  For i₂=(i/2)−2, apply input |aᵢ_{₂}₊₁ [symbol]   , |aᵢ_{₂}₊₁ [symbol]   and partial product |T₂₊ᵢ_{₂}_{,i-1-2*i}_{₂} [symbol]   to an
uncomputation gate;
If i > n−1 and i/=2n−3, and i is odd, then
  For i₃=((2n−i−3)/2) apply input |aᵢ₋ₙ₊ᵢ_{₃}₊₁ [symbol]   , |aₙ₋ᵢ_{₃}₋₁ [symbol]   and partial product |Tᵢ_{₃} _{+1,i-1-2*i}_{₃} [symbol]   to an
uncomputation gate;
If i > n − 1 and i is even, then apply input |aᵢ₋ₙ₊₁ [symbol]   , |aₙ₋₁ [symbol]   and partial product |T_{0,i-1} [symbol]   to an
uncomputation gate;
If i/=2n−4 and i/=2n−6, then
  For i₄ =(2n−i−4)/2 apply input |aᵢ₋ₙ₊ᵢ_{₄}_{+1]} [symbol]   , |aₙ₋ᵢ_{₄}_{-1]} [symbol]   and partial product |Tᵢ_{₄}_{+1,i-1-2*(i}_{₄}₋₁₎ [symbol]   to
an uncomputation gate;
```

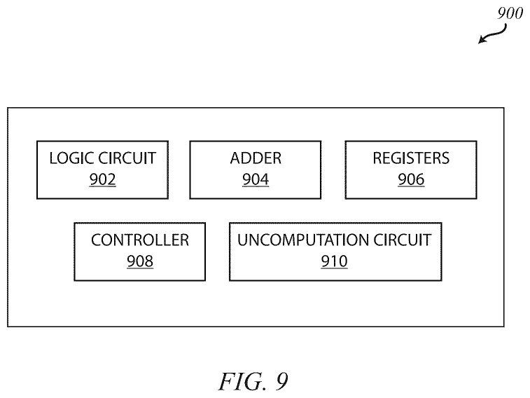

FIG. 9 is a block diagram of a system 900, in accordance with various examples. In an example, the system 900 is suitable for implementing quantum squaring, such as described above herein. For example, the system 900 may include a logic circuit 902, adder (or computation) 904, and registers 906. The logic circuit 902 may include any suitable number of sub-circuits or logic gates arranged in any suitable architecture. For example, the logic circuit 902 may include one or more circuits or gates suitable for performing logical-AND operations as described above herein. The logic circuit 902 may also include one or more circuits or gates suitable for performing CNOT operations as described above herein. In an example, the adder 904 is a quantum adder, such as a Gidney's adder, as described above herein. While shown as a single adder 904, in some examples multiple adders 904 may be included and may be cascaded or otherwise arranged to perform a series of operations. In an example, the registers 906 may include any suitable number and format of registers, such as at least the registers |A [symbol] , |P [symbol] , |T [symbol] and/or |V [symbol] . In some examples, the system 900 includes a controller 908 to control or otherwise direct operation of one or more other components of the system 900, such as by providing input values (e.g., a) for quantum squaring by the system 900. The system 900 may further include a quantum logic circuit, which may be referred to as an uncomputation circuit, 910 suitable for performing uncomputation as described above herein.

For purposes of the disclosure herein, the term “comprising” includes “consisting” or “consisting essentially of.” Further, for purposes of the disclosure herein, the term “including” includes “comprising,” “consisting,” or “consisting essentially of.”

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k* (R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. As used herein, the term “and/or” can mean one, some, or all elements depicted in a list. As an example, “A and/or B” can mean A, B, or a combination of A and B. Use of broader terms such as comprises, includes, having, etc. should be understood to provide support for narrower terms such as consisting of, consisting essentially of, comprised substantially of, etc.

What is claimed is:

1. An apparatus, comprising:
a first logic circuit configured to provide partial products of a multi-bit value, the partial products stored as ancilla;
a quantum adder coupled to the first logic circuit, the quantum adder configured to add the partial products to provide a square of the multi-bit value; and
a quantum logic circuit comprising uncomputation gates, the quantum logic circuit configured to uncompute the partial products based on the partial products and the multi-bit value.

2. The apparatus of claim 1, wherein the first logic circuit includes an array of logical components configured to perform logical AND operations among the multi-bit value to determine the partial products, wherein a quantity of the partial products is equal to a square of the multi-bit value.

3. The apparatus of claim 1, wherein the quantum logic circuit includes quantum components configured to perform uncomputation of logical AND operations.

4. The apparatus of claim 3, wherein uncomputing the partial products reverts the ancilla to values held prior to processing of the multi-bit value by the first logic circuit.

5. The apparatus of claim 1, wherein the adder is a Gidney's adder.

6. An apparatus, comprising:
a logic circuit configured to determine partial products for a multi-bit value, the partial products stored as ancilla;
a computation circuit configured to iteratively process the partial products in a loop with carry output values to determine a square of the multi-bit value; and
an uncomputation circuit configured to reverse operations of the computation circuit and the logic circuit to restore the ancilla to a value held prior to determining the partial products.

7. The apparatus of claim 6, wherein the computation circuit includes a quantum full adder and a quantum half adder, the quantum full adder and the quantum half adder configured to iteratively process the partial products and interim results determined by the quantum full adder or the quantum half adder in a loop.

8. The apparatus of claim 6, wherein the uncomputation circuit is configured to perform garbage removal to reverse operations of the computation circuit and the logic circuit.

9. The apparatus of claim 6, wherein the logic circuit is configured to determine the partial products by performing AND logical operations among bits of the multi-bit value.

10. A method, comprising:
determining partial products for a multi-bit value;
performing quantum full adder and quantum half adder operations sequentially in a loop for a programmed number of iterations;
storing a result of the quantum full adder and quantum half adder operations as a square of the multi-bit value; and
uncomputing the partial products and the quantum full adder and quantum half adder operations.

11. The method of claim 10, wherein the quantum full adder and quantum half adder operations are performed by Gidney's adders.

12. The method of claim 10, further comprising performing logical AND operations on the multi-bit value to determine the partial products.

13. The method of claim 12, further comprising performing AND inverse operations on the partial products to perform the uncomputing.

14. The method of claim 10, further comprising storing the partial products in a first quantum register.

15. The method of claim 14, further comprising zero-padding the first quantum register to prepare values of the first quantum register for the quantum full adder and quantum half adder operations.

16. The method of claim 15, wherein a first portion of the sum bits from an iteration of the quantum full adder and quantum half adder operations are bits of the square of the multi-bit value.

17. The method of claim 16, further comprising storing a second portion of the sum bits of the iteration of the quantum full adder and quantum half adder operations in a second quantum register as a remainder.

18. The method of claim 17, wherein a second iteration of the quantum full adder and quantum half adder operations subsequent to the iteration of the quantum full adder and quantum half adder operations receives partial products from the first quantum register and the second portion of the sum bits as input operands.

19. The method of claim 10, wherein uncomputing the partial products and the quantum full adder and quantum half adder operations reverses operations performed to determine the square of the multi-bit value.

20. The method of claim 19, wherein reversing the operations comprises restoring values of the first quantum register and the second quantum register to values held prior to determining the partial products.
